(19) United States
(12) Patent Application Publication
(10) Pub. No.: US 2010/0192181 A1
(43) Pub. Date: Jul. 29, 2010

(54) System and Method to Navigate an Electonic Program Guide (EPG) Display

(75) Inventor: Lee G. Friedman, Alpharetta, GA (US)

Correspondence Address: AT & T LEGAL DEPARTMENT - Toler;ATTN: PATENT DOCKETING, ROOM 2A-207, ONE AT & T WAY, BEDMINISTER, NJ, 07921, US

(73) Assignee: AT&T INTELLECTUAL PROPERTY I, L.P., Reno, NV (US)

(21) Appl. No.: 12/361,685

(22) Filed: Jan. 29, 2009

(51) Int. Cl. H04N 5/445; H04N 5/44

(52) U.S. Cl. 725/44; 348/734; 348/E05.096

(57) ABSTRACT

Systems and methods of navigating and presenting electronic program guide data are provided. A particular method includes displaying an electronic program guide (EPG) detail view at a display device and displaying an EPG map view at the display device concurrently with the EPG detail view. The EPG detail view includes more detailed information than the EPG map view regarding a selected portion of the EPG map view. The selected portion includes a first range of times and a first set of channels. The method also includes receiving EPG control input to change the portion of the EPG map view that is selected. The method further includes modifying the EPG detail view in response to the EPG control input.

### FIELD OF THE DISCLOSURE

The present disclosure is generally related to navigating an electronic program guide.

### BACKGROUND

The range of media content that is available to users is ever increasing. One technique that has been developed to help the users navigate through the content is through the use of an electronic program guide (EPG). The EPG provides information regarding what media content is available and how to access the media content. The EPG may also provide additional functionality to enable users to access particular media content represented in the EPG.

### BRIEF DESCRIPTION OF THE DRAWINGS

FIG. 1 is a block diagram of an embodiment of a system to present an electronic program guide (EPG) display;

FIG. 2 is a flowchart of a first embodiment of a method to present an EPG display;

FIG. 3 is a flowchart of a second embodiment of a method to present an EPG display;

FIG. 4 is a flowchart of a third embodiment of a method to present an EPG display;

FIG. 5 is a flowchart of a fourth embodiment of a method to present an EPG display;

FIG. 6 is an illustration of a first particular embodiment of an EPG display;

FIG. 7 is an illustration of a second particular embodiment of an EPG display;

FIG. 8 is an illustration of a third particular embodiment of an EPG display;

FIG. 9 is an illustration of a fourth particular embodiment of an EPG display;

FIG. 10 is an illustration of a fifth particular embodiment of an EPG display;

FIG. 11 is a diagram illustrating a method of determining motion of a controller with respect to a display device; and

FIG. 12 is a block diagram of an illustrative general computing system.

### DETAILED DESCRIPTION

Systems and methods of presenting electronic program guide data are provided. A particular method includes displaying an electronic program guide (EPG) detail view at a display device and displaying an EPG map view at the display device concurrently with the EPG detail view. The EPG detail view includes more detailed information than the EPG map view regarding a selected portion of the EPG map view. The selected portion includes a first range of times and a first set of channels. The method also includes receiving EPG control input to change the portion of the EPG map view that is selected. The method further includes modifying the EPG detail view in response to the EPG control input.

In a particular embodiment, a system includes an electronic program guide (EPG) module to access EPG data and to generate an EPG display based on the EPG data. The EPG display includes an EPG map view and an EPG detail view. The EPG map view indicates available EPG data and highlights a selected portion of the EPG data. The EPG detail view includes more detailed information than the EPG map view regarding a first range of times and a first set of channels of the selected portion of the EPG data. The system also includes a display module to send the EPG display to a display device.

In a particular embodiment, a computer-readable storage medium includes computer-executable instructions that, when executed, cause a processor to send an electronic program guide (EPG) display to a display device. The EPG display includes an EPG detail view and an EPG map view. The EPG detail view includes detailed information regarding a selected portion of the EPG map view. The selected portion includes a first range of times and a first set of channels. The computer-readable storage medium also includes computer-executable instructions that, when executed, cause the processor to modify the EPG detail view in response to received EPG control input to change the portion of the EPG map view that is selected to include a second selected portion.

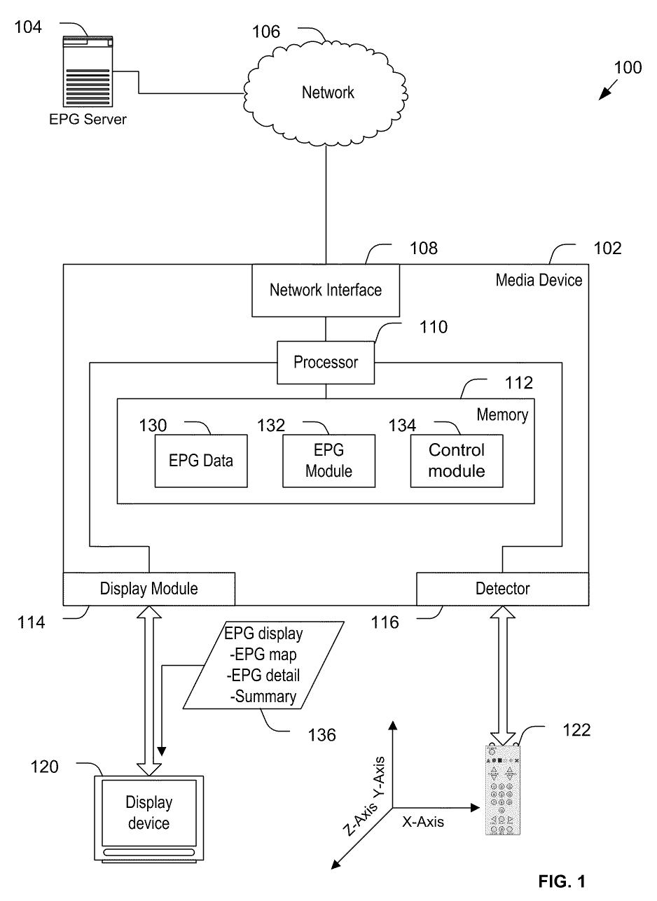

FIG. 1 illustrates a particular embodiment of a system to present an electronic program guide (EPG) display at a display device. The system 100 includes a media device 102 coupled to a display device 120. The media device 102 may provide media for presentation via the display device 120. For example, the media device 102 may include a set-top box device adapted to receive multi-media data via a network 106 for presentation at the display device 120. Additionally, the media device 102 may receive EPG data from an EPG server 104 via the network 106. The media device 102 may send an EPG display 136 to the display device 120 to assist a user in selecting media for presentation.

In a particular embodiment, the media device 102 includes a network interface 108 adapted to receive data from the network 106. The media device 102 also includes a processor 110 and a memory 112 accessible to the processor 110. The memory 112 includes instructions executable by the processor 110 to carry out various functions of the media device 102. The media device 102 also includes a display module 114 adapted to interface with the display device 120 to send data to the display device 120 for presentation at the display device 120. The media device 102 also includes a detector 116. In a particular embodiment, the detector 116 is an optical device adapted to detect light emitted by light emitting diodes (LEDs) of a remote control device 122, and to determine motion of the remote control device 122 based on the detected light. For example, the LEDs may be a predetermined distance apart, and the optical device may be adapted to detect light from the LEDs and to determine how far the remote control device 122 is located from the detector 116 based on the detected light. The detector 116 may be adapted to determine motion of the remote control device 122 along an X-axis, a Y-axis and a Z-axis with respect to the display device 120, or with respect to the detector 116. The Z-axis may be approximately perpendicular to a plane of the display device 120. The X-axis and the Y-axis are approximately parallel to the plane of the display device 120. For example, the X-axis may be horizontal (e.g., right and left) with respect to the display device 120 and the Y-axis may be vertical (e.g., up and down) with respect to the display device 120. Components of motion of the remote control device 122 along the X-axis and the Y-axis may be referred to as lateral motion.

In a particular embodiment, the media device 102 includes EPG data 130 received from the EPG server 104 and stored in the memory 112. The EPG data 130 includes a listing of programs, times at which the programs may be available, and channels at which the programs may be received. The EPG data 130 may also include more detailed information such as descriptive information about particular programs, metadata associated with the programs (such as, the type of program, a length of the program and so forth).

The memory 112 may also include an EPG module 132. The EPG module 132 is adapted to access the EPG data 130 and to generate an EPG display 136 based on the EPG data 130. The EPG display 136 includes an EPG map view indicating available EPG data 130 and highlighting a selected portion of the EPG data 130. The EPG display 136 also includes an EPG detail view. The EPG detail view includes more detailed information than the EPG map view regarding a first range of times and a first set of channels of the selected portion of the EPG data 130. The EPG display 136 may also include a summary. The summary may include information identifying the selected portion. For example, the summary may include text specifying the first range of times and the first set of channels.

The display module 114 is adapted to send the EPG display 136 to the display device 120 for presentation. The memory 112 also includes a control module 134. The control module 134 is adapted to send a control input to the EPG module 132 based on detected movement of the remote control device 122 by the detector 116. The EPG module 132 modifies the EPG display 136 based on the control input. For example, when the detected movement of the remote control device 122 changes a distance between the remote control device 122 and the display device 120 or the detector 116 (i.e., the motion is toward or away from the detector 116), the control input as sent by the control module 134 may be to change (e.g., increase or decrease) a size of at least one of the first range of times and the first set of channels. For example, when the remote control device 122 is moved toward the display device 120, the selected portion of the EPG data may be decreased to a smaller range of times, to a smaller set of channels, or both. In another example, when the remote control device 122 is moved away from the display device 120, the selected portion of the EPG data 130 may be increased to a larger range of times, to a larger set of channels, or both. In another example, when the detected movement is lateral with respect to the display device 120 or the detector 116, the control input sent by the control module 134 may be to select at least one second set of channels, at least one second range of times, or both. For example, when the remote control device 122 is moved up, the control input may be to select a second set of channels that are above the first set of channels in the EPG display 136. For example, when the remote control device 122 is moved down, the control input may be to select a second set of channels that are below the first set of channels in the EPG display 136. In another example, when the remote control device 122 is moved to the left, the control input may be to select a second range of times that are to the left of the first set of channels in the EPG display 136. To illustrate, the EPG display 136 may be arranged with earlier times to the left and later times to the right in the display. Thus, when the remote control device 122 is moved left, an earlier range of times may be selected. In another example, when the remote control device 122 is moved to the right, the control input may be to select a second range of times that are to the right of the first set of channels in the EPG display 136

In a particular embodiment, the detector 116 is also adapted to receive an action input indication from the remote control device 122. The action input indication indicates a portion of the motion of the remote control device 122 that is to be monitored. For example, in a first action state, the detector 116 may monitor a component of movement of the remote control device 122 along a first axis, such as the Z-axis. In another example, in a second action state, the detector 116 may monitor a second component of movement of the remote control device 122 along a second axis, such as the X-axis and a third component of the movement of the remote control device 122 along a third axis, such as along the Y-axis. Thus, by selecting the action input indication at the remote control device 122, the user may indicate whether X-axis motion, Y-axis motion, or Z-axis motion, or a combination thereof, is to be detected.

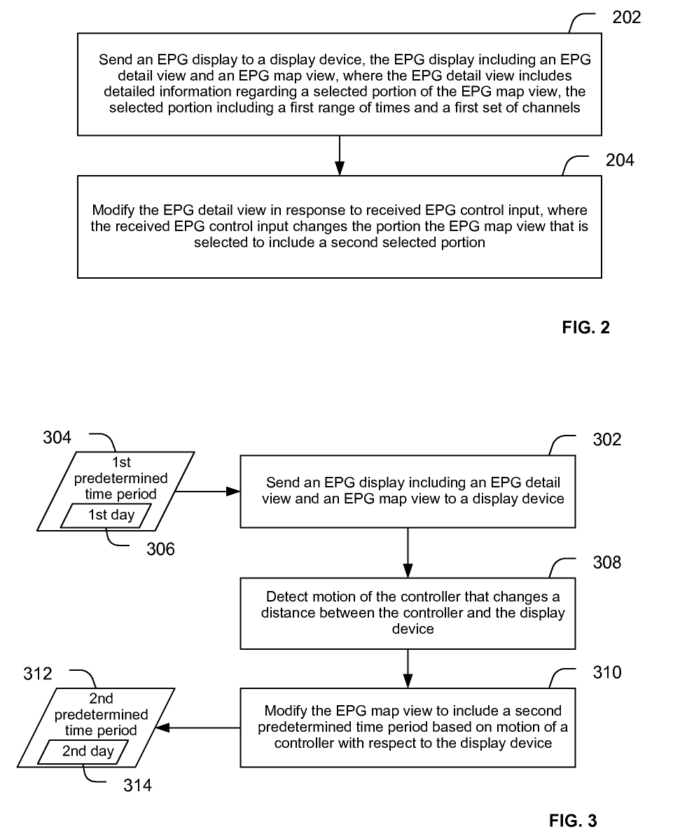

FIG. 2 depicts a first particular embodiment of a method to present an electronic program guide (EPG) display at a display device. The method includes, at 202, sending an EPG display to a display device. The EPG display includes an EPG detail view and EPG map view. The EPG detail view includes detailed information regarding a selected portion of the EPG map view. The selected portion includes a first range of times and a first set of channels. In a particular embodiment, the EPG map view includes information regarding all available EPG data. For example, a set-top box device, such as the media device 102 illustrated in FIG. 1, may store EPG data. The EPG data may include information about programs available via a plurality of channels over a specified predetermined period of time, such as one week, two weeks, and so forth. The EPG map view may include information regarding all available EPG data. The EPG detail view may include more detailed information regarding a selected portion of the EPG map view.

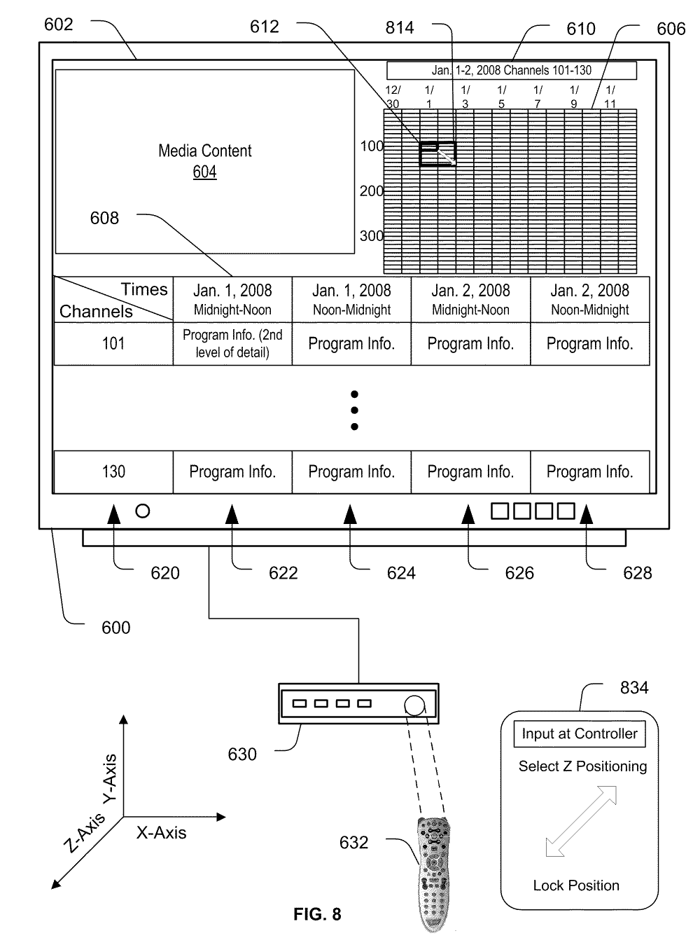

The method also includes, at 204, modifying the EPG detail view in response to received EPG control input. The received EPG control input changes the portion of the EPG map view that is selected to include a second selected portion. In a particular embodiment, the second selected portion may include at least a portion of the first range of times and first set of channels. For example, the second selected portion may include a sub-set of the first range of times, a sub-set of the first set of channels, or both. That is, the second selected portion may be a zoomed-in portion of the first selected portion. In another example, the second selected portion may be larger than the first range of times and the first set of channels and include the first range of times and first set of channels. That is, the second selected portion may be a zoomed-out portion of the EPG data including the first selected portion. An illustrative embodiment of zooming with respect to a selected portion of the EPG map view is provided with respect to FIG. 8.

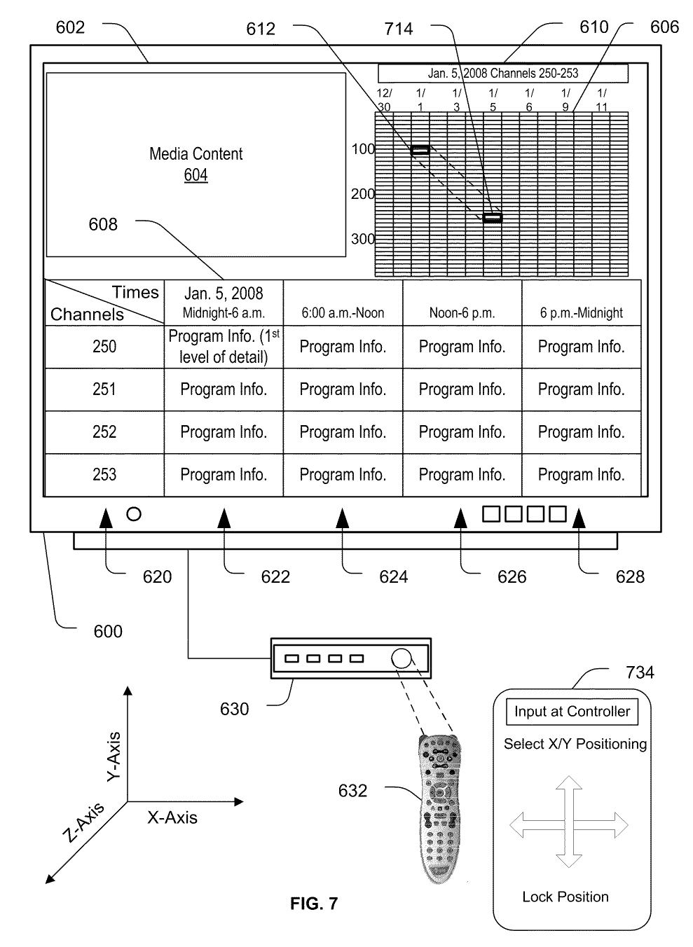

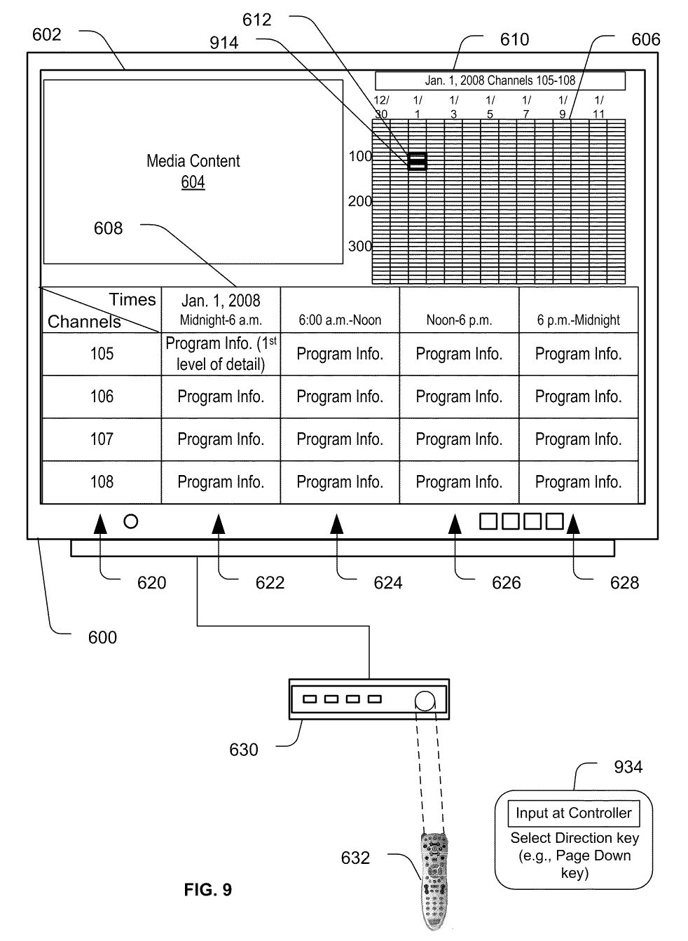

In another example, the second selected portion may be the same size as the first selected portion but not include the entire first selected portion. To illustrate, the second selected portion may be a different set of channels, a different range of times, or both. In a particular embodiment, the EPG control input may select a later or earlier time, may select a different set of channels, or both. A particular embodiment of selecting a second portion is discussed with reference to FIGS. 7 and 9.

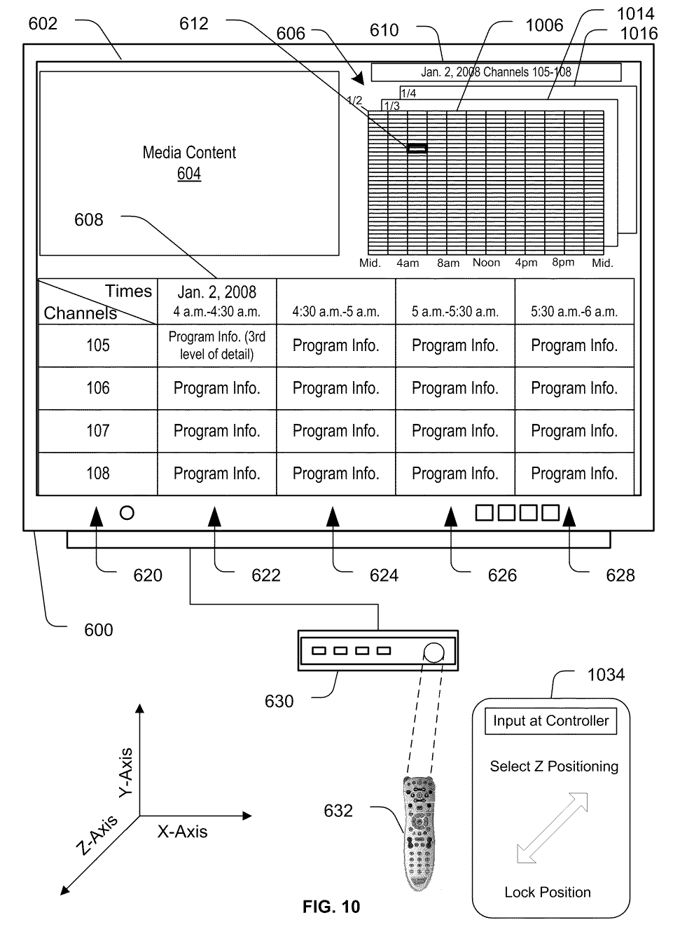

FIG. 3 depicts a second particular embodiment of a method to present an electronic program guide (EPG) display at a display device. The method includes, at 302, sending an EPG display including an EPG detail view and an EPG map view to a display device. In a particular embodiment, the EPG map view includes information regarding a first predetermined time period 304. For example, the first predetermined time period 304 may include a first day 306. The method also includes, at 308, detecting motion of a controller that changes a distance between the controller and the display device (e.g., motion toward or away from the display device). The method also includes, at 310, modifying the EPG map view to include a second predetermined time period 312 based on the motion of the controller with respect to the display device. In a particular embodiment, the second predetermined time period 312 includes a second day 314. A particular embodiment of changing from the first predetermined time period 304 to the second predetermined time period 312 is discussed with reference to FIG. 10.

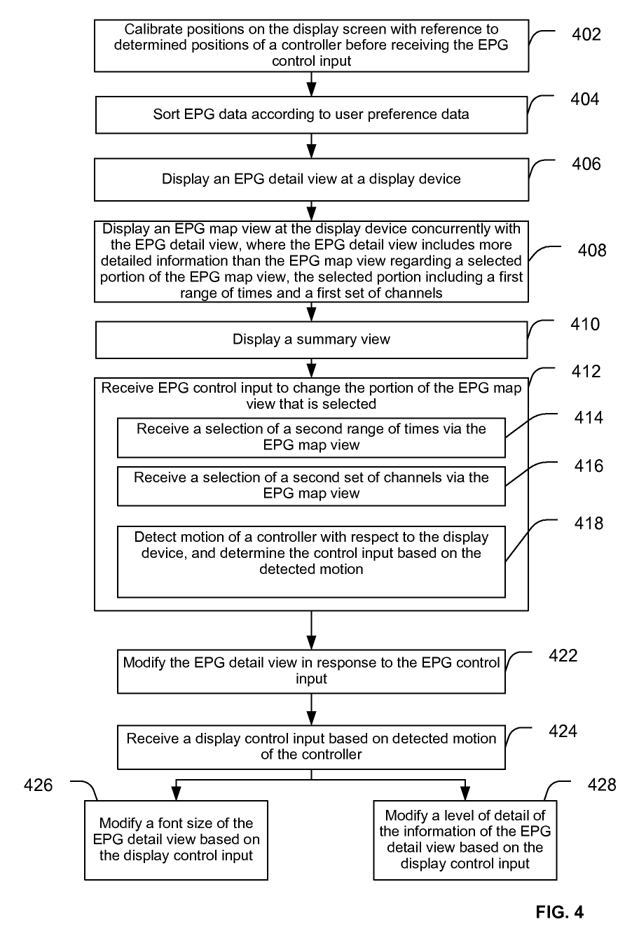

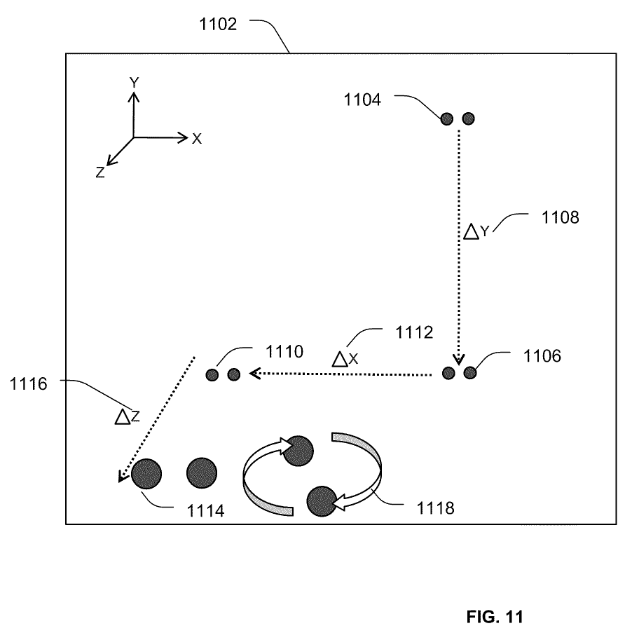

FIG. 4 depicts a third particular embodiment of a method to present an electronic program guide (EPG) display. The method includes, at 402, calibrating positions of a display with reference to positions of a controller. A particular embodiment of determining the position of the controller with respect to the display device is discussed with reference to FIG. 11. A method of determining the position of the controller, such as the method discussed with reference to FIG. 11, may be used to calibrate positions of the display screen with reference to positions of the controller and to determine control input based on motion of the controller.

The method also includes, at 404, sorting EPG data according to user preference data. To illustrate, the user preference data may specify one or more favorite channels, one or more blocked channels, or an order or arrangement of the channels (such as, sorting or grouping the channels by type of content associated with channels).

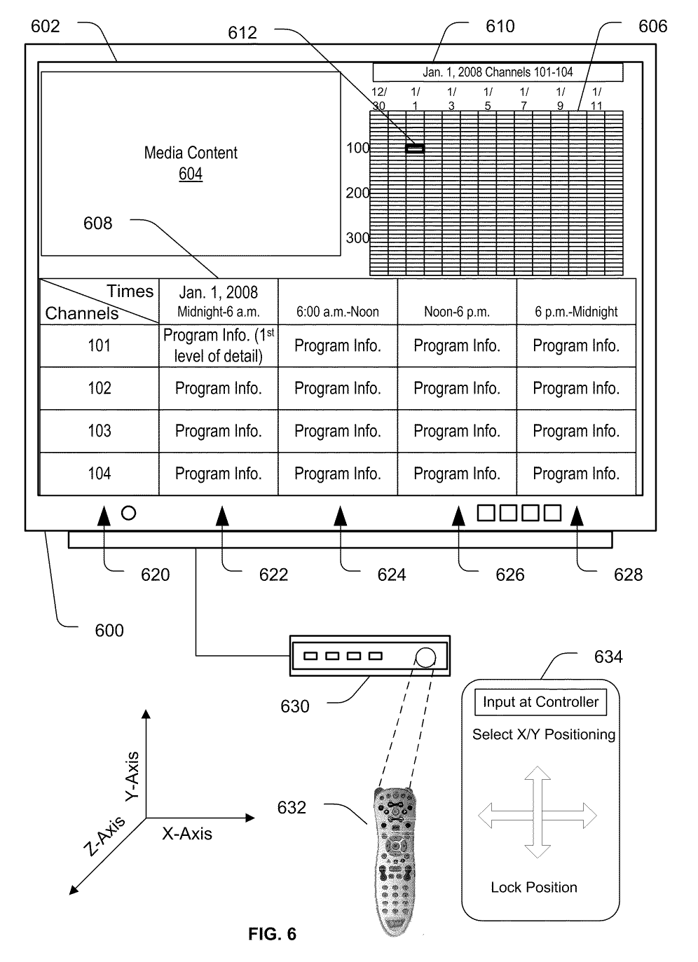

The method also includes, at 406, displaying an EPG detail view at a display device, and, at 408, displaying an EPG map view at the display device concurrently with the EPG detail view. The EPG map view, the EPG detail view, or both may be sorted according to the user preference data. The EPG detail view includes more detailed information than the EPG map view regarding a selected portion of the EPG map view. In a particular embodiment, the EPG map view includes information regarding all available electronic program guide data. For example, a set-top box device may store EPG data for a predetermined time period in the future, such as one week, two weeks, or another predetermined time period. The EPG map view may include information regarding all channels and all time periods from the available EPG data. The EPG detail view may include more detailed information than the EPG map view regarding a selected portion of the EPG data. The selected portion may include a first range of times and a first set of channels selected in the EPG map view. The method also may include, at 410, displaying a summary view. The summary view includes information identifying the first range of times and the first set of channels. The EPG detail view, the EPG map view, and the EPG summary view are discussed in more detail with reference to FIGS. 6-9.

The method also includes, at 412, receiving EPG control input to change the portion of the EPG map view that is selected. In a particular embodiment, receiving the EPG control input includes, at 414, receiving a selection of a second range of times via the EPG map view. In another particular embodiment, receiving the EPG control input includes, at 416, receiving a selection of a second set of channels via the EPG map view. In a particular embodiment, receiving the EPG control input includes, at 418, detecting motion of a controller with respect to the display device and determining the control input based on the detected motion.

The method also includes, at 422, modifying the EPG detail view in response to the EPG control input. The method may also include, at 424, receiving a display control input based on detected motion of the controller. In a particular embodiment, in response to the display control input, the method may include, at 426, modifying a font size of the EPG detail view based on the display control input. For example, the display control input may be based on motion of the controller that changes a distance between the controller and the display device (e.g., motion toward or away from the display device). For example, in response to the controller being moved toward the display device, the font size of the EPG detail view may be increased, and, in response to the controller being moved away from the display device, the font size may be decreased. Changing the font size of the EPG detail view may change an amount of information that can be displayed in the EPG detail view.

In another example, in response to receiving the display control input, the method may include, at 428, modifying a level of detail of the information presented in the EPG detail view. For example, in response to motion of the controller toward the display device, the level of detail of the information presented in the EPG detail view may be increased. To illustrate, more information about programs represented in the range of times and set of channels selected may be presented. In another example, in response to detected motion of the controller away from the display device, the level of detail of the information presented in the EPG detail view may be decreased. That is, less information about each particular program in the first range of times and first set of channels may be presented.

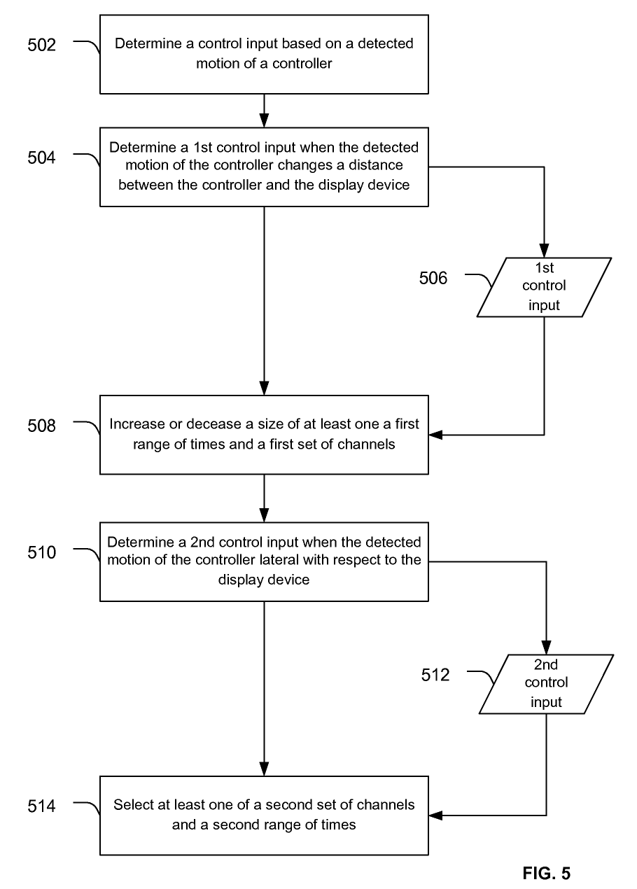

FIG. 5 depicts a fourth particular embodiment of a method to present an electronic program guide (EPG) display. In the method of FIG. 5, an EPG display including an EPG map view and an EPG detail view is displayed at a display device. The EPG detail view includes more detailed information regarding a selected portion of the EPG map view. The method includes, at 502, determining a control input based on detected motion of a controller. For example, at 504, a first control input 506 is determined when the detected motion of the controller changes a distance between the controller and the display device (i.e., is toward or away from the display device). In response to the first control input 506, the method includes, at 508, changing a size (e.g., increasing or decreasing) of a first range of times, a first set of channels, or both. A selected portion of the EPG map view that is displayed in the EPG detail view may include the first range of times and the first set of channels. Thus, increasing the size of the first range of times or the first set of channels increases a size of the selected portion of the EPG map view. That is, the second selected portion of the EPG map view may include the first range of times and an additional range of times, the first set of channels and an additional set of channels. Further, decreasing the size of the first range of times or the first set of channels decreases the size of the selected portion of the EPG map view. That is, the second selected portion of the EPG map view may include a sub-set of the first range of times, a sub-set of the first set of channels, or sub-sets of each. Additionally, the EPG detail view may be modified to correspond to the selected portion of the EPG map view.

In another example, at 510, the method may include determining a second control input 512 based on detected motion of the controller that is lateral with respect to the display device (e.g., left and right, up and down, or both). At 514, the second control input 512 may select a second set of channels, a second range of times, or both. The second set of channels or a second range of times may have the same size as the first range of times and the first set of channels.

FIG. 6 is an illustration of a first particular embodiment of an electronic program guide (EPG) display 602 on a display device 600. The display device 600 may receive media content and EPG display data from a media device, such as a set-top box (STB) device 630. The STB device 630 may receive control input 634 via a controller, such as a remote control device 632. In response to the control input 634, the STB device 630 may modify the EPG display 602 sent to the display device 600.

As illustrated, the display 602 includes media content 604, such as television content, video-on-demand (VOD) content, pay-per-view content, or other media content that can be viewed while the EPG is displayed. The display 602 also includes an EPG map view 606. The display 602 also includes an EPG detail view 608. The EPG detail view 608 includes more detailed information than the EPG map view 608. For example, the EPG detail view 608 may include information about a selected portion 612 of the EPG map view 606. In a particular embodiment, the EPG map view 606 includes all available EPG data. For example, the STB device 630 may store EPG data received from an EPG server (such as, the EPG server 104 of FIG. 1). The EPG data may cover a predetermined time period, such as a few days, a week, two weeks or another time period. The EPG map view 606 may include all of the stored EPG data. The selected portion 612 of the EPG map view 606 may include only a portion of the stored EPG data, such as a particular range of times and a set of channels. The EPG detail view 608 may include more detailed information about media content of the selected portion 612. Additionally, the display 602 may include a summary view 610. The summary view 610 may include information that identifies the selected portion 612.

In a particular, the EPG detail view 606 includes a grid showing program information for programs available at various times within the selected portion 612 of the EPG data, and on various channels. For example, the EPG detail view 608 may include a first column 620 that identifies channels within the selected portion 612 of the EPG data. Additionally, the EPG detail view 608 may include one or more additional columns, such as a second column 622, a third column 624, a fourth column 626 and a fifth column 628, that include programming information descriptive of various programs. The programming information may have a first level of detail. For example, the programming information may include titles of programs, ratings of the programs, artists associated with the programs, program descriptions, other information descriptive of the programs, or any combination thereof.

In a particular embodiment, the STB device 630 may be adapted to detect motion of the remote control device 632 relative to the display device 600 or the STB device 630. The STB device 630 may determine control commands based on the detected motion. The control input 634 may be based on motion of the remote control device 632, selection of one or more keys of the remote control device 632, or any combination thereof. For example, the control input 634 to select the selected portion 612 of the EPG data may include selecting an action mode key of the remote control device 632 to indicate that lateral motion (e.g., X-axis motion, Y-axis motion, or both) of the remote control device 632 should be monitored. The STB device 630 may monitor the motion of the remote control device 632 by tracking the location of a plurality of light emitting diodes (LEDs) of the remote control device 632. After the action mode key has been selected, the remote control device 632 may be moved. A component of the motion of the remote control device 632 along the X-axis, the Y-axis, or both may be monitored. The action mode key may be selected again to select the selected portion 612 of the EPG data.

FIG. 7 is an illustration of a second particular embodiment of an electronic program guide (EPG) display 602. FIG. 7 illustrates selecting a second portion 714 of the EPG data via the EPG map view 610. In a particular embodiment, control input 734 to select the second portion 714 may include selection of an action mode key of the remote control device 632 to indicate that lateral motion (e.g., X-axis motion, Y-axis motion, or both) of the remote control device 632 should be monitored. After the action mode key is selected, the remote control device 632 may be moved. A component of the motion of the remote control device 632 along the X-axis, the Y-axis, or both may be monitored. In response to the detected motion, a highlighted portion of the EPG map view 610 may be relocated to the second selected portion 714. When the highlighted portion is at a desired location, the action mode key may be selected again to select the second portion 714 of the EPG data.

In response to selection of the second portion 714, the EPG detail view 608 may be modified. For example, as illustrated, the second selected portion 714 includes a second set of channels and a second range of times, and the EPG detail view 608 displays more detailed information than the EPG map view 606 regarding media content available in the second set of channels during the second range of times.

FIG. 8 is an illustration of a third particular embodiment of an electronic program guide (EPG) display 602. FIG. 8 illustrates selecting a second portion 814 of the EPG data via the EPG map view 606. In a particular embodiment, control input 834 to select the second selected portion 814 may include selection of an action mode key of the remote control device 632 to indicate that motion of the remote control device 632 toward or away from the STB device 630 (e.g., Z-axis motion) should be monitored. After the action mode key is selected, the remote control device 632 may be moved. A component of the motion of the remote control device 632 along the Z-axis may be monitored. In response to the detected motion, a highlighted portion of the EPG map view 606 may be expanded (to zoom out the selection) or contracted (to zoom in the selection) to select the second selected portion 814. When the highlighted portion has a desired size, the action mode key may be selected again to select the second portion 814 of the EPG data.

In response to selection of the second portion 814, the EPG detail view 608 may be modified. For example, as illustrated, the second selected portion 814 is larger than the first selected portion 612. That is, the first selected portion 612 includes a first range of times and a first set of channels. The second selected portion 814 includes the first range of times as well as a second range of times. Further, the second selected portion 814 includes the first set of channels as well as a second set of channels. The EPG detail view 608 displays more detailed information than the EPG map view 606 regarding media content available in the second selected portion 814. For example, the EPG detail view 608 may be modified to include a second level of detail. Additionally, the summary view 610 may be modified to identify the second selected portion 814.

FIG. 9 is an illustration of a fourth particular embodiment of an electronic program guide (EPG) display 602. FIG. 9 illustrates selecting a second portion 914 of the EPG data via interaction with the EPG detail view 608. In a particular embodiment, control input 934 to select the second selected portion 914 may include selection of a direction key of the remote control device 632. The direction key may indicate that the EPG detail view 608 should be moved down one screen or up one screen to see different channels, or left one screen or right one screen to see different times. For example, as illustrated, the direction key may include a page down key. In response to the page down key, the EPG detail view 608 may show a second set of channels and the EPG map view 606 may be modified to indicate which portion of the EPG data is selected.

FIG. 10 is an illustration of a fifth particular embodiment of an electronic program guide (EPG) display 602. In the embodiment illustrated in FIG. 10, the EPG map view 606 includes a plurality of pages. Each page includes EPG data regarding a predetermined time period, such as a day, a week, or another time period. For example, the EPG map view 606 may include a first day 1006, a second day 1014, and a third day 1016. The EPG map view 606 also includes a first selected portion 612. In a particular embodiment, control input 1034 to select a second selected portion during a different time period (e.g., the second day 1014) may include selection of an action key of the remote control device 632. The action key may indicate that motion of the controller 632 that changes a distance of the controller from the display device (i.e., a component of motion along the Z-axis). The controller 632 may then be moved, and in response to detection of the motion, the EPG map view 606 may be modified by changing to display a different predetermined time period, such as the second day 1014 or the third day 1016.

Referring to FIG. 11, a diagram 1102 illustrating determining motion of a controller (e.g., a remote control device) with respect to a display device is shown. The diagram 1102 shows a plurality of LED modules as detected at a first location 1104 by a detector of a media device. For example, the detector may include the detector 116 of the media device 102 as discussed with reference to FIG. 1. The diagram 1102 also shows the LED modules at a second location 1106. A distance between the first location 1104 and the second location 1106 is illustrated as ΔY 1108. The diagram 1102 also includes a third location 1110 a distance ΔX 1112 from the second location 1106. The distances ΔY 1108 and ΔX 1112 may be determined based on a distance between pixels of the detector that receive light from the LED modules. In another example, the distance ΔY 1108 and ΔX 1112 may be determined by determining an angle at which the light is received at the detector.

The diagram 1102 also includes a fourth location 1114 that is a distance ΔZ 1116 from the third location 1110. The distance ΔZ 1116 may be determined based on a comparison of a known spacing between the LED modules and a perceived or measured distance between the LED modules at the detector. For example, the LED modules may be a known distance apart, and light from the LED modules may be detected by pixels of the detector. A distance between pixels that detect the LEDs may be determined and a distance between the detector and the LED modules may be determined based on the known distance between the LED modules and the detected distance. Additionally, an orientation of the LED modules may be detected to determine a rotation 1118.

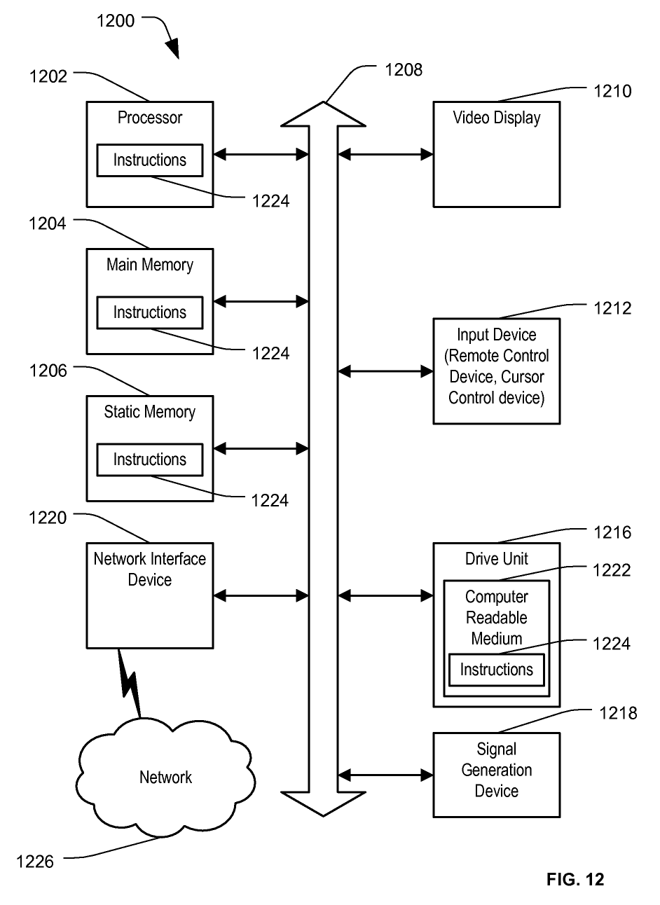

Referring to FIG. 12, an illustrative embodiment of a general computer system is shown and is designated 1200. The computer system 1200 can include a set of instructions that can be executed to cause the computer system 1200 to perform any one or more of the methods or computer based functions disclosed herein. The computer system 1200 may operate as a standalone device or may be connected, e.g., using a network, to other computer systems or peripheral devices.

In a networked deployment, the computer system 1200 may operate in the capacity of a server or as a client user computer in a server-client user network environment, or as a peer computer system in a peer-to-peer (or distributed) network environment. The computer system 1200 can also be implemented as or incorporated into various devices, such as a personal computer (PC), a tablet PC, a set-top box (STB), a desktop computer, or any other machine capable of executing a set of instructions (sequential or otherwise) that specify actions to be taken by that machine. In a particular embodiment, the computer system 1200 can be implemented using electronic devices that provide voice, video or data communication. Further, while a single computer system 1200 is illustrated, the term “system” shall also be taken to include any collection of systems or sub-systems that individually or jointly execute a set, or multiple sets, of instructions to perform one or more computer functions.

As illustrated in FIG. 12, the computer system 1200 may include a processor 1202, e.g., a central processing unit (CPU), a graphics processing unit (GPU), or both. Moreover, the computer system 1200 can include a main memory 1204 and a static memory 1206, that can communicate with each other via a bus 1208. As shown, the computer system 1200 may further include a video display unit 1210, such as a liquid crystal display (LCD), an organic light emitting diode (OLED), a flat panel display, a solid state display, a projection display or a cathode ray tube (CRT). Additionally, the computer system 1200 may include an input device 1212, such as a keyboard, a cursor control device (such as a mouse), a remote control device, and so forth. The computer system 1200 can also include a disk drive unit 1216, a signal generation device 1218, such as a speaker or remote control, and a network interface device 1220.

In a particular embodiment, as depicted in FIG. 12, the disk drive unit 1216 may include a computer-readable medium 1222 in which one or more sets of instructions 1224, e.g. software, can be embedded. Further, the instructions 1224 may embody one or more of the methods or logic as described herein. In a particular embodiment, the instructions 1224 may reside completely, or at least partially, within the main memory 1204, the static memory 1206, and/or within the processor 1202 during execution by the computer system 1200. The main memory 1204 and the processor 1202 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 1224 or receives and executes instructions 1224 responsive to a propagated signal, so that a device connected to a network 1226 can communicate voice, video or data over the network 1226. Further, the instructions 1224 may be transmitted or received over the network 1226 via the network interface device 1220.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the disclosed embodiments are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be reduced. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method, comprising:
displaying an electronic program guide (EPG) detail view at a display device;
displaying an EPG map view at the display device concurrently with the EPG detail view, wherein the EPG detail view includes more detailed information than the EPG map view regarding a selected portion of the EPG map view, the selected portion including a first range of times and a first set of channels;
receiving EPG control input to change the portion of the EPG map view that is selected; and
modifying the EPG detail view in response to the EPG control input.

2. The method of claim 1, wherein receiving the EPG control input includes receiving a selection of a second range of times via the EPG map view.

3. The method of claim 1, wherein receiving the EPG control input includes receiving a selection of a second set of channels via the EPG map view.

4. The method of claim 1, wherein receiving the EPG control input includes:
detecting motion of a controller with respect to the display device; and
determining the control input based on the detected motion.

5. The method of claim 4, wherein determining the control input based on the detected motion comprises determining a first control input when the detected motion of the controller changes a distance between the controller and the display device, wherein the first control input changes a size of the first range of times and a size of the first set of channels.

6. The method of claim 4, wherein determining the control input based on the detected motion comprises determining a second control input when the detected motion of the controller is laterally with respect to the display device, wherein the second control input selects at least one of a second range of times and a second set of channels of the EPG map.

7. The method of claim 1, further comprising displaying a summary view, wherein the summary view includes information identifying the first range of times and the first set of channels.

8. The method of claim 1, further comprising:
receiving a display control input based on detected motion of a controller, and
modifying a font size of the EPG detail view based on the display control input.

9. The method of claim 1, further comprising:
receiving a display control input based on detected motion of a controller, and
modifying a level of detail of the detail information of the EPG detail view based on the display control input.

10. The method of claim 1, further comprising calibrating positions on the display device with reference to determined positions of a controller before receiving the EPG control input.

11. The method of claim 1, wherein the EPG map view includes information regarding a first predetermined time period, and wherein the EPG control input causes the EPG map view to be modified to include a second predetermined time period based on motion of a controller with respect to the display device.

12. The method of claim 11, wherein the first predetermined time period is a first day and the second predetermined time period is a second day.

13. The method of claim 12, wherein the EPG map view changes from the first day to the second day in response to detected motion of the controller toward or away from the display device.

14. A system, comprising:
an electronic program guide (EPG) module to access EPG data and to generate
an EPG display based on the EPG data, wherein the EPG display includes:
an EPG map view indicating available EPG data and highlighting a selected portion of the EPG data; and
an EPG detail view including more detailed information than the EPG map view regarding a first range of times and a first set of channels of the selected portion of the EPG data; and
a display module to send the EPG display to a display device.

15. The system of claim 14, further comprising:
a detector to detect a movement of a controller relative to the detector; and
a control module to send a control input to the EPG module based on the detected movement, wherein the EPG module modifies the EPG display based on the control input.

16. The system of claim 15, wherein the detector detects the movement of the controller based on light from a plurality of light emitting diodes (LEDs).

17. The system of claim 16, wherein the plurality of LEDs are a predetermined distance from one another.

18. The system of claim 15, wherein, when the detected movement changes a distance between the controller and the detector, the control input sent by the control module is to increase or to decease a size of at least one of the first range of times and the first set of channels.

19. The system of claim 15, wherein, when the detected movement is at least one of horizontal and vertical with respect to the detector, the control input sent by the control module is to select at least one of a second set of channels and a second range of times.

20. The system of claim 15, wherein the detector is further to receive an action input indication from the controller, wherein:
when the action input indication includes a first action state, the detector monitors a first component of the movement of the controller along a first axis; and
when the action input indication includes a second action state, the detector monitors a second component of the movement of the controller along a second axis and a third component of the movement of the controller along a third axis.

21. A computer-readable storage medium, comprising:
computer-executable instructions that, when executed, cause a processor to send an electronic program guide (EPG) display to a display device, the EPG display including an EPG detail view and an EPG map view, wherein the EPG detail view includes detailed information regarding a selected portion of the EPG map view, wherein the selected portion includes a first range of times and a first set of channels; and
computer-executable instructions that, when executed, cause the processor to modify the EPG detail view in response to received EPG control input to change the portion of the EPG map view that is selected to include a second selected portion.

22. The computer-readable storage medium of claim 21, wherein channels identified in the EPG map view are sorted according to user preference data.

23. The computer-readable storage medium of claim 21, wherein the first set of channels identified in the EPG detail view are sorted according to user preference data.

24. The computer-readable storage medium of claim 21, wherein the second selected portion of the EPG map view includes the first range of times, a second range of times, the first set of channels, and a second set of channels, and wherein the EPG detail view is modified in response to the EPG control input to include the first range of times, the second range of times, the first set of channels, and the second set of channels.
